(19) United States
(12) Patent Application Publication
(10) Pub. No.: US 2026/0177408 A1
(43) Pub. Date: Jun. 25, 2026

(54) INTEGRATED FLOW RATE SENSOR

(71) Applicant: Cooper-Standard Automotive Inc., NORTHVILLE, MI (US)

(72) Inventor: Brian J. Cardwell, Ypsilanti, MI (US)

(73) Assignee: Cooper-Standard Automotive Inc., NORTHVILLE, MI (US)

(21) Appl. No.: 19/424,588

(22) Filed: Dec. 18, 2025

Related U.S. Application Data
(60) Provisional application No. 63/736,832, filed on Dec. 20, 2024.

(51) Int. Cl. G01F 1/075

(52) U.S. Cl. CPC G01F 1/075

(57) ABSTRACT

A flow rate sensor that can be integrated with a component of a fluid system includes a housing having fluid ports attached to the component and an internal cavity having a spindle and a rotor comprised of a plurality of paddles attached to a hub rotatably mounted on the spindle. The paddles rotate the hub around the spindle when a fluid is introduced into the cavity from a fluid port. A magnetic element attached to the hub rotates along with the rotor. A magnetic switch located in a sealed compartment is in magnetic alignment with the magnetic field produced by the magnetic element. Rotation of the magnetic element causes the magnetic switch to generate electrical signals corresponding to the rate of fluid flowing into the sensor from the component.

### CROSS-REFERENCE TO RELATED APPLICATION AND PRIORITY CLAIM

This application claims priority under 35 U.S.C. § 119(e) to U.S. Provisional Patent Application No. 63/736,832 filed on Dec. 20, 2024. This provisional application is hereby incorporated by reference in its entirety.

### TECHNICAL FIELD

This disclosure is directed to a flow rate sensor, particularly to a flow rate sensor that can be integrated with a component of a fluid system and that measures the flow rate of a fluid flowing from the component using a magnetic effect.

### BACKGROUND

Flow rate measuring devices measure the rate of fluid flow through a fluid system or through components of a fluid system. For example, in an electrified motor vehicle, a fluid rate measuring device may be used to measure the rate of fluid coolant flowing to a battery to maintain optimal operating temperature. The rate of flow through the fluid system is adjusted based on the measured flow rate.

Currently known fluid systems are provided with separate stand-alone flow rate measuring devices that are fluidically connected to piping that transport fluids through the fluid system. Certain fluid rate measuring devices may make use of a magnetic rotatable element, wherein the rotation of the rotatable magnetic element generates a magnetic field which is detected by a sensing coil. The magnetic field induces an electrical current signal in the sensing coil, namely an alternating current signal, having a frequency that corresponds to the flow of the fluid across the rotatable element.

The stand-alone flow rate measuring devices described above add complexity and increased component cost to a fluid system. It would be desirous from a complexity and cost basis to provide a sensor that can measure flow rate that could easily be integrated with a component of the fluid system, such as for example, a fluid pump or a fluid valve. The sensor providing the additional functionality of measuring the rate of flow of the fluid through the component or the fluid system. For example, a flow rate sensor integrated into a motor driven fluid pump would provide a component that pumps fluid through the fluid system as well as a sensor that measures the rate of flow from the pump. The measured rate of flow may then be used to adjust the flow rate in the fluid system by adjusting the speed of the motor.

It would therefore be desirable to provide a low-cost sensor which can provide measurements of fluid flow and that can be integrated into the components of a fluid system.

### SUMMARY

This disclosure relates to a flow rate sensor for a fluid system that measures the flow rate of a fluid flowing from a component of the fluid system using a magnetic effect.

In a first aspect of the disclosure, a flow rate sensor that can be integrated with a component of a fluid system comprises a rotatable magnetic element positioned in a fluid flow from the component, wherein rotation of the rotatable magnetic element depends on the fluid flow. A magnetic switch is located in a sealed compartment in magnetic alignment with a magnetic field produced by the magnetic element, wherein rotation of the magnetic element causes the magnetic switch to generate electrical signals corresponding to the rate of fluid flow.

In a second aspect of the disclosure, a sensor is disclosed that can be integrated with a component of a fluid system that measures a rate of fluid flow from the component. The sensor comprises a housing having an internal cavity and a spindle and a rotor having a hub rotatably mounted on the spindle. Rotation of the rotor depends on the fluid flow component. A magnetic element is mounted to the hub, wherein rotation of the rotor causes rotation of the magnetic element. A magnetic switch is located in a sealed compartment in magnetic alignment with the magnetic field produced by the magnetic element. Rotation of the magnetic element causes the magnetic switch to generate electrical signals corresponding to the rate of fluid flow from the component.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is an exemplary perspective view of the housing of a first embodiment of the flow rate sensor in accordance with the present disclosure;

FIG. 2 is an exemplary perspective view of the housing and rotor of the first embodiment of the flow rate sensor;

FIG. 3 is an exemplary perspective view of an assembled flow rate sensor in accordance with the first embodiment;

FIG. 4 is a sectional elevation through line A-A of FIG. 3;

FIG. 5 is an exemplary perspective of FIG. 3 having the cover hidden and illustrating a Hall Effect switch, switch leads and terminals located as they would be located on the cover;

### DETAILED DESCRIPTION

The figures discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

The flow rate sensor according to a preferred embodiment of the invention, includes a rotor comprised of a plurality of paddles extending from a central hub that is rotatably coupled to a spindle. The spindle is mounted within a cylindrical housing. The rotor is arranged to freely rotate around the spindle within the housing. A top surface of the hub is provided with a permanent ring magnet. An annular cover mounted to the housing over the impeller includes a bi-polar Hall effect (HE) magnetic switch mounted within a compartment of the cover in magnetic alignment with the ring magnet. The axial distance of HE magnetic switch to the ring magnet when the magnetic pole segments of the ring magnet are aligned with the HE magnetic switch is approximately between 1 to 8 mm.

Fluid introduced into the housing from a fluid system causes the rotor to turn about the spindle. Rotation of the rotor brings each of the ring magnets south and north segments into alignment with the HE magnetic switch once every 180-degree rotation of the rotor. The magnetic field produced by the south segment of the ring magnet triggers the HE magnetic switch “on” causing the HE magnetic switch to produce a positive electrical signal. When the north segment of the ring magnet moves into alignment with the HE magnetic switch, the magnetic switch is triggered “off” and the electrical signal drops to a voltage less than the “on” voltage signal, until the south segment of the ring magnet aligns with the HE magnetic switch again to trigger the HE magnetic switch back on. Rotation of the impeller by the rate of fluid flow into the housing causes the HE magnetic switch to produce a series of electrical pulse output signals. The frequency of the pulses, i.e., the number of electrical pulses, depends on the rate of fluid flow entering the flow rate sensor and applied to the rotor. The frequency of the pulses, during a unit of time, can be used to measure the rate of flow of a fluid through the flow rate sensor.

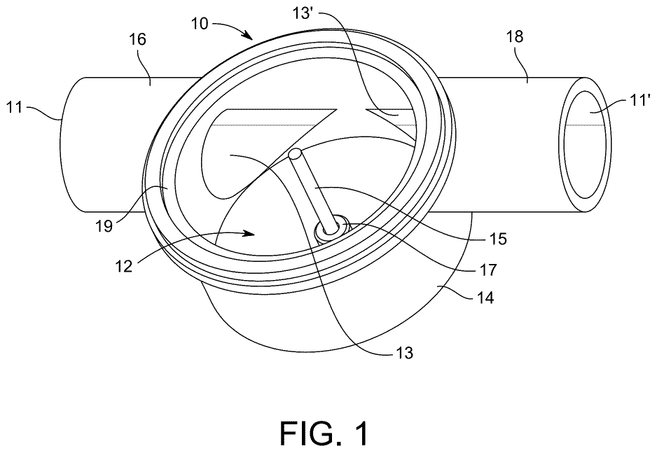

FIGS. 1 through 5 show an exemplary embodiment of the flow rate sensor of the present disclosure. A housing 10 includes a cylindrical body having an internal cavity 12 defined by an annular wall 14. An annular top surface 19 extends about a top peripheral edge of wall 14. A pair of fluid ports 16 and 18 are each attached to housing 10 extending from opposing ends of housing 10. Fluid ports 16, 18 may be the input or output fluid ports of a fluid system component (not shown), or pipelines that attach to the fluid ports of a fluid system component, such as, a fluid pump, a fluid valve, a tank or fluid vessel. For example, fluid port 160 may be the fluid outlet of a fluid pump whereby, the flow rate sensor may be built into the fluid pump and an integral element of the fluid pump assembly that measures fluid flow from the pump. In certain other embodiments the fluid port 18 may be attached as the inlet port (not shown) of another fluid system component, such as a tank or vessel, which measures the flow of fluid from the fluid system into the tank of vessel. In certain other embodiments the fluid ports 16, 18 may have ridges, barbs and other frustoconical protrusions (not shown) extending about each fluid port 16, 18, arranged to accept on the ridges and protrusions the interior wall of a semi-rigid or flexible pipeline and frictionally retain the pipeline to a respective port by the mechanical expansion of the conduit material over features.

Each of the fluid ports 16, 18 include an internal passage 11, 11′ respectively, that extend to an opening 13, 13′ that extends through wall 14 and opens into cavity 12. The housing 10 can be formed from a suitable thermoplastic material specific to the fluids contained in the fluid system where the flow rate sensor will be used. A metal spindle 15 is mounted to a boss 17 located in a central location in cavity 12. Boss 17 extending into the cavity 12 from a floor of housing 10.

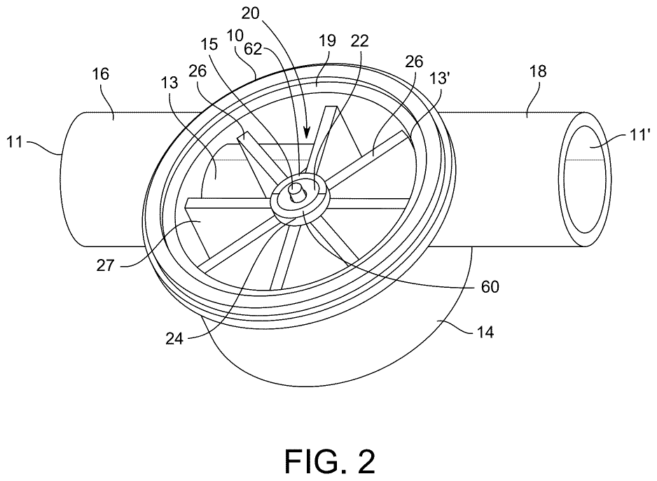

As best seen in FIG. 2, rotor 20 comprises a hub 22 having a centrally located bore, a permanent ring magnet 24 is mounted on an outer peripheral edge of hub 22 using any convenient means for attaching the magnet 24 to hub 22. Such as, for example using an adhesive. A plurality of paddles 26 extend outward from an outer surface of hub 22. Each paddle 26 is equally spaced from the other around hub 22. In the present disclosure eight paddles 26 are shown, however, any number of paddles lesser than or greater than the eight shown may be attached to the hub 22.

Rotor 20 is installed in cavity 12 by mating spindle 15 with a centrally located bore of hub 22. The rotor 20 is housed in cavity 12, with edge portions 27 of each paddle 26 in close proximity to an inner surface of wall 14. When mounted to spindle 15 the rotor 20 spins freely about the spindle 15 allowing each paddle 26 to enter into an axial alignment with openings 13 and 13′. The axial alignment allows fluid flowing into fluid ports 16, 18 from a fluid system, to drive the rotor 20 about the spindle 15. For example, when fluid is introduced into passage 11 of fluid port 16 the fluid flows out of opening 13. The fluid exists opening 13 and pushes against paddles 26. The force applied by the fluid flowing from opening 13 pushes on a paddle 26 to cause rotor 20 to rotate in a clockwise direction. The rotation brings the next paddle 26 in alignment with opening 13 which is pushed by the fluid flowing from opening 13 and in turn brings the next paddle 26 into the fluid flow. The fluid entering cavity 12 exits the cavity from opening 13′ and out of fluid port 18, and therefore causing the rotor 20 to continuously spin about a spindle 15, as long as fluid flows from opening 13. It will be appreciated that rotor 20 can also spin about the spindle 15 in a counterclockwise direction. Wherein the fluid flows from fluid port 18 and opening 13′ to fluid port 16 to drive rotor 20 in a counterclockwise direction.

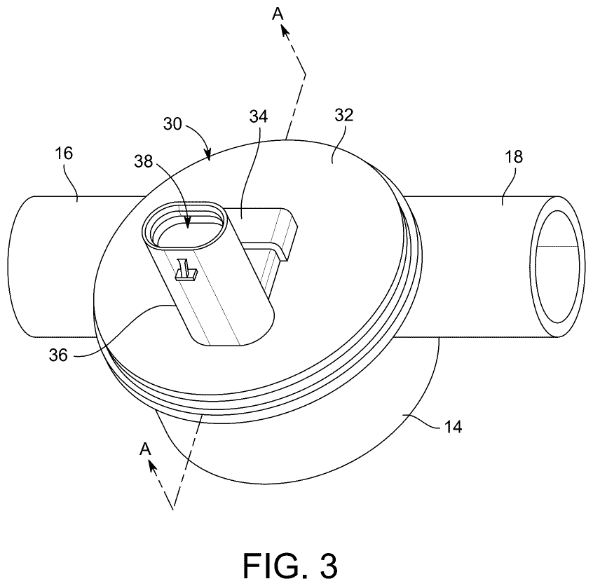

The ring magnet 24 includes a magnetic pole pair comprising a south pole 60 and north pole 62 segment. Each pole segment is located on opposite ends of the ring magnet 24. Rotation of the rotor 20 by the fluid flowing into housing 10 causes the ring magnet 24 to rotate. For example, a 360-degree rotation of rotor 20, will cause the south pole segment 60 to rotate 360-degrees around spindle 15. It will be appreciated by those skilled in the art that the ring magnet may contain more than the one pole pair shown in FIG. 2. For example, the ring magnet 24 may contain two or more pole pairs, each pole pair having a north pole segment next to an adjoining south pole segment equally spaced about the ring magnet 24. A cover 30 is attached to housing 10 over rotor 2 as shown in FIG. 3. The present disclosure

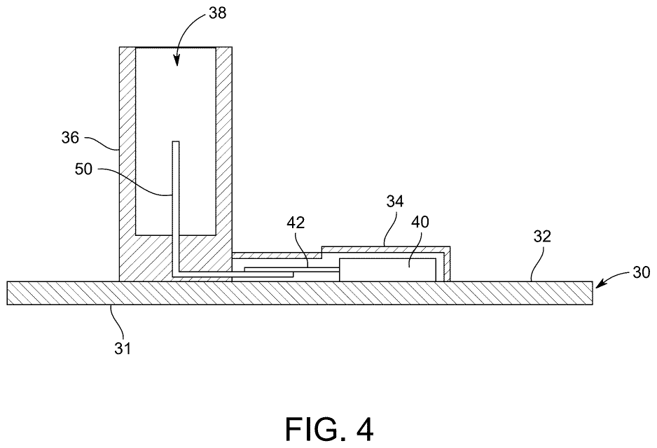

With reference to the sectional elevation of FIG. 4, a top surface 32 of cover 30 includes a centrally located sensor compartment 34. The top surface of cover 30 further includes a connector housing 36 extending from one end of the sensor compartment 34. As is shown in FIG. 4, sensor compartment 34 integrally houses internally within compartment 34 the bipolar HE magnetic switch 40 and a pair of switch leads 42 (only one shown in FIG. 4). The HE magnetic switch 40 is sealed within sensor compartment 34. The HE magnetic switch 40 may be molded into sensor compartment 34 at the time the cover is molded or placed on the top surface of 32 of cover 30 and the sensor compartment 34 laser welded to top surface 32. The sensor compartment 34 seals the HE magnetic switch 40 from the fluid contained in cavity 12 of housing 10 and from any external environmental contaminants that may be present where the flow rate sensor is located. The cover 30 is formed from the same thermoplastic material as the housing 10.

The connector housing 36 also includes a pair of electrical terminals 50 mounted internally in the connector opening 38 that extend from connector opening 38 and into to sensor compartment 34 (only one shown in FIG. 4). Each electrical terminal of the pair of electrical terminals 50 electrically connect to each one of the pair of HE magnetic switch leads 42 within sensor compartment 34. Any convenient method for connecting each terminal 50 to a respective switch lead 42 may be used. Such as, for example, soldering, crimping or laser welding. The connector opening 38 is arranged to receive within the connector opening an electrical connector (not shown) that electrically connects electrical terminals 50 to a remotely located flow conversion circuit.

A peripheral edge of a bottom surface 31 of cover 30 is arranged to be permanently fixed to the top surface 19 of housing 10. The cover 30 can be fixed by laser welding, or any other method that causes the top cover to be permanently fixed to the housing 10 and which makes a fluid tight assembly between the cover 30 and the housing 10.

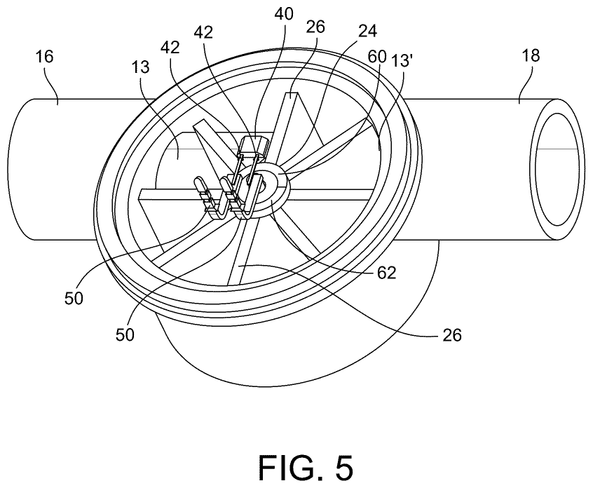

FIG. 5 shows the flow rate sensor with the cover 30 hidden but with the HE magnetic switch 40 and switch leads 42 located as they would be in sensor compartment 34. Terminals 50 are also shown as they would be located and connected to the switch leads 42 in sensor compartment 34 and within and connector housing 36. As illustrated in FIG. 5, the HE magnetic switch 40 is in a magnetic alignment over ring magnet 24. The distance between the HE magnetic switch 40 and the ring magnet 24 being between 1 mm to 8 mm. The distance is established to provide a sufficiently strong magnetic field to penetrate the cover 30 and trigger the HE magnetic switch.

As was explained above, fluid introduced into housing 10 from fluid port 16 causes the rotor 24 to turn about spindle 15. As the fluid traverses between openings 13, 13′ rotation of the rotor 20 brings each of the ring magnets 24 south and north segments 60 and 62 respectively, into magnetic alignment with the HE magnetic switch 40 once every 180-degree rotation of the rotor. The magnetic field produced by the south segment 60 of the ring magnet 24 triggers the HE magnetic switch 40 “on” causing the HE magnetic switch 40 to produce a positive voltage signal. When the north segment 62 moves into alignment with the HE magnetic switch 40, the HE magnetic switch is triggered “off” and the electrical signal drops to a zero voltage, or to a voltage that is less than the “on” voltage, until the south segment 60 aligns with the HE magnetic switch again to trigger the HE magnetic switch 40 back on. Rotation of rotor 20 by the rate of fluid flow into the housing 10 causes the HE magnetic switch 40 to produce a series of electrical pulse output signals. As was explained in FIG. 2, the ring magnet 24 may contain more than the one pole pair. It will be well understood by those skilled in the art that the ring magnet 24 may contain, for example, 4 to 6 pole pairs. A ring magnet 24 having a greater number of pole pairs provides increased sensitivity of the sensor to the fluid flow through the sensor due to the greater number of pulses generated by the HE magnetic switch 40 per 360 degrees rotation of rotor 20.

The output signals are electrically connected to terminals 50 from leads 42 of the HE magnetic switch 40. The frequency of the pulses, i.e., the number of electrical pulses produced by the rotation of the rotor 20, is dependent on the rate of fluid flow entering the flow rate sensor. The greater the flow rate the greater the frequency. The electrical pulse signals produced by the HE magnetic switch 40 are connected via terminals 50 to a flow conversion circuit (not shown). The flow conversion circuit may utilize the pulses with a unit of time, such as for example 60 seconds, to calculate a rate of flow of a fluid through the flow rate sensor.

It may be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” or “controller” within a claim is understood and intended to refer to structures known to those skilled in the relevant art, as further modified or enhanced by the features of the claims themselves and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A flow rate sensor integrated with a component of a fluid system, the flow rate sensor measuring a rate of fluid flow comprising:
a rotatable magnetic element positioned in the fluid flow, wherein rotation of the rotatable magnetic element depends from the fluid flow; and
a magnetic switch located in a sealed compartment in magnetic alignment with a magnetic field produced by the magnetic element, wherein rotation of the magnetic element causes the magnetic switch to generate electrical signals corresponding to the rate of fluid flow.

2. The flow rate sensor of claim 1, wherein the rotatable magnetic element is a permanent ring magnet having at least a south and a north magnetic segment.

3. The flow rate sensor of claim 1, wherein the magnetic switch is arranged to sense a magnetic field, wherein the magnetic switch produces a positive electrical signal when the magnetic switch senses the magnetic field from the south magnetic segment and does not produce an electrical signal when the magnetic switch senses the north magnetic segment.

4. The flow rate sensor of claim 2, wherein the ring magnet is attached to a rotor positioned in the fluid flow and wherein the fluid flow rotates the rotor and the ring magnet.

5. The flow rate sensor of claim 4, wherein the flow rate sensor includes a housing having a cylindrical cavity and a spindle extending from the floor of the cavity, the rotor housed in the cavity and rotatably mounted on the spindle.

6. The flow rate sensor of claim 5, wherein the housing includes first and second fluid ports fluidically connected to first and second openings in the cavity, wherein the fluid flow enters the cavity from the first opening and exits the cavity from the second opening.

7. The flow rate sensor of claim 5, wherein the flow rate sensor includes a cover mounted over the cavity and the rotor, the cover including the sealed compartment.

8. The flow rate sensor of claim 7, wherein the cover further includes a connector housing having electrical terminals electrically connected to the magnetic switch, the connector housing arranged to receive a connector from an external flow conversion circuit and communicatively connect the electrical signals corresponding to the rate of fluid flow to the flow conversion circuit.

9. The flow rate sensor of claim 3, wherein the magnetic switch is a bipolar Hall effect magnetic switch.

10. A sensor integrated with a component of a fluid system for measuring a rate of fluid flow from the component, the sensor comprising:
a housing having an internal cavity and a spindle;
a rotor having a hub rotatably mounted on the spindle, wherein rotation of the rotor depends from the fluid flow from the component;
a magnetic element mounted to the hub, wherein rotation of the rotor causes rotation of the magnetic element; and
a magnetic switch located in a sealed compartment in magnetic alignment with a magnetic field produced by the magnetic element, wherein rotation of the magnetic element causes the magnetic switch to generate electrical signals corresponding to the rate of fluid flow from the component.

11. The sensor of claim 10, wherein the magnetic element is a ring magnet having at least a south and a north magnetic segment.

12. The sensor of claim 10, wherein the hub includes a bore centrally located in the hub and the spindle is mated to the bore allowing the rotor to rotate around the spindle.

13. The sensor of claim 10 wherein the hub includes an exterior surface having a plurality of paddles extending from the external surface and into the cavity.

14. The sensor of claim 13, wherein the housing includes first and second openings in the cavity, wherein the first opening is fluidically connected to a first fluid port is integrally connected to a fluid outlet of the component and the second opening is connected to a second fluid port fluidically connected to the fluid system, wherein a portion of the each of the plurality of paddles is in alignment with the first and second openings that cause a fluid entering the cavity from the first opening to apply a force to a respective one of the plurality of paddles before exiting the second opening and the second fluid port, wherein rotation of the hub brings the next paddle of the plurality of paddles in alignment with the first opening producing continuous rotation of the hub based on the rate of fluid flow entering the cavity.

15. The sensor of claim 10, wherein the magnetic element is a ring magnet having at least a south and a north magnetic segment.

16. The sensor of claim 15, wherein the sensor includes a cover mounted over the housing cavity and the rotor, the cover including the sealed sensor compartment.

17. The sensor of claim 16, wherein the cover is laser welded to the housing.

18. The sensor of claim 11, wherein the magnetic switch device is a bipolar Hall effect (HE) magnetic switch.

19. The sensor of claim 18, wherein the (HE) magnetic switch produces a positive going voltage signal when it senses a magnetic field corresponding to the south magnetic segment of the ring magnet and ceases producing voltage signals when the HE magnetic switch senses a magnetic field corresponding to the north magnetic segment generating electrical pulses having a frequency corresponding to the rate of fluid flow.

20. The sensor of claim 19, wherein the cover further includes a connector housing having electrical terminals electrically connected to the magnetic switch, the connector housing arranged to receive a connector from an external flow conversion circuit to communicatively connect the electrical pulses from the magnetic switch to the flow conversion circuit.
